(19) United States
(12) Patent Application Publication
(10) Pub. No.: US 2005/0279006 A1
(43) Pub. Date: Dec. 22, 2005

(54) Lighted fish hooks

(76) Inventors: Joseph Trembone, Bedford Corners, NY (US); Scott A. Teal, Wappingers Falls, NY (US)

Correspondence Address: Karl F. Milde, Jr., Esq.;MILDE & HOFFBERG, LLP, Suite 460, 10 Bank Street, White Plains, NY, 10606, US

(21) Appl. No.: 10/966,975

(22) Filed: Oct. 16, 2004

Related U.S. Application Data
(60) Provisional application No. 60/580,002, filed on Jun. 16, 2004.

(51) Int. Cl. A01K 85/01; A01K 83/00

(52) U.S. Cl. 43/17.6; 43/43.16; 43/17.5

(57) ABSTRACT

An illuminated fish hook utilizing a self contained lithium polymer battery and light unit, preferably an LED, permanently attached to the hook, and which may be provided with an on/off switch.

### FIELD OF THE INVENTION

The present invention relates to lighted or illuminated fishing tackle.

### BACKGROUND OF THE INVENTION

Traditionally, lights have been used by fishermen to accomplish two purposes. For night fishing, lights have been attached to the bobber so that the fishermen could see when there was a hit on the line. For example, the Nite Brite™ lighted float utilizes a replaceable lithium polymer battery/LED light.

In addition, lights and luminous means have been used in conjunction with hooks and lures to attract fish especially in turbid or low light water conditions. U.S. Pat. No. 3,940,868 to Northcutt discloses a fishing lure with a light source mounted to the shank of the hook. The light source, an LED, is attached to a power source which is separately mounted, on the fishing line. Such a construction requires the separate mounting of the power source, a step which is unnecessary when using the lighted fish hooks of the present invention. In addition, attaching the battery to the line may cause fraying, crimping or damage to the line, which might increase the risk of line breakage. This is especially important when fishing for large trophy fish which may apply stress on line which approaches the maximum load that the line can withstand.

U.S. Pat. No. 5,495,690 to Hunt describes an electronic lure having a light source which is mounted to the shank of the hook. The lighted lure of Hunt also requires a mounting plate for the battery, and biasing means to hold the battery to the mounting plate; both of which are provided on the shank of the hook. The battery mounting plate dictates the shape of lure, and has nothing to do with attractiveness to fish. In addition, the mounting plate prevents use of the hook with a wide variety of bait, and especially with artificial plastic bait having a preformed channel therethrough, for stringing the bait along the shank of the hook. In addition, the fishermen is acquired to assemble the battery with the light source before commencing fishing, a step that is not required in using the lighted fishing hook of present invention.

U.S. Pat. No. 6,318,016 to Ellig describes a luminous fishing lure using a fiber-optic tube comprising fluorescent dye polymer, to simulate the lateral line of a bait fish, and/or a luminous fish eye. The fluorescent light polymer is many orders of magnitude dimmer than the LED light of the present invention, and hence is of limited usefulness, especially in turbid or low light water conditions.

### SUMMARY OF THE INVENTION

It is an object to present invention to provide a superior fish hook having illumination to attract greater numbers of fish, in a wide variety of situations, especially low natural light circumstances.

It is an object of the present invention to provide an illuminated hook which requires no assembly, and can be used immediately upon attaching the hook to the line.

It is an object of the present invention to provide an illuminated fish hook in any basic hook design, which does not alter the profile of the basic hook, permitting it to be used with all the existing tackle for the basic hook, including artificial bait.

It is an object of the present invention to provide an illuminated fish hook which does not require the user to attach a battery to the hook or the line.

It is an object of the present invention to provide an illuminated hook with many hours of illumination, so that the fishermen needn't be concerned with turning the hook light on or off.

It is an object of the present invention to provide an illuminated hook for the fisherman who likes to use live bait, providing him with a hook with a degree of attraction unheard of in the past.

These objects, as well as other objects which will become apparent from the discussion that follows, are achieved, in accordance with the present invention, which comprises an illuminated fish hook comprising a hook comprising a shaft, with a curved hook at one end, and a line connector that the other end; and, an LED with a battery, attached to the shaft of the hook. The illuminated fish hook may further comprise a switch, to turn the LED on and/or off. The LED with battery may be attached to the shaft by any conventional means such as soldering or gluing, through the use of pressure clips. The illuminated fish hook may further comprise a head attached to the shaft at the line connector end. The illuminated fish hook of the present invention may be constructed with hook of any shape or design, including hook intended to be strung through preformed channels in artificial bait. In an illuminated Keeper Hook, if desired, the light (with battery) may be attached to the keeper rod rather than the shaft. For a full understanding of the present invention, reference should now be made to the following detailed description of the preferred embodiments of the invention as illustrated in the accompanying drawings.

### BRIEF DESCRIPTION OF THE DRAWINGS

FIG. 1A is a side plan view of an illuminated fish hook of the present invention constructed from a simple hook.

FIG. 1B is a side plan view of the illuminated fish hook of FIG. 1A, with the switch engaged and the light illuminated.

FIG. 2A is a side plan view of an illuminated tube jig head hook according to the present invention.

FIG. 2B is a side plan view of the hook of FIG. 2A, disposed through the preformed channel of a plastic tube tail skirt.

FIG. 3A is a side view of and illuminated shad head jig head hook according to the present invention.

FIG. 3B is a side of view and of the hook of FIG. 3A disposed through a preformed channel of a plastic shad body.

FIG. 4A is a side view of an illuminated offset worm hook according to the present invention.

FIG. 4B is a side view of the hook of FIG. 4A, with the line connector end disposed through one end of a large rubber slug-go stickbait, and the hook disposed through the body of the rubber stickbait.

FIG. 5 is a side view of an illuminated “weedless” hook according to the present invention.

FIG. 6 is a side view of an illuminated keeper style hook according the present invention.

FIG. 7 is a perspective view of a trailer hook with light attachment means.

FIG. 8 is a side view of a double hook arrangement.

FIG. 9 is a side view of a trailer hook arrangement.

### DESCRIPTION OF THE PREFERRED EMBODIMENTS

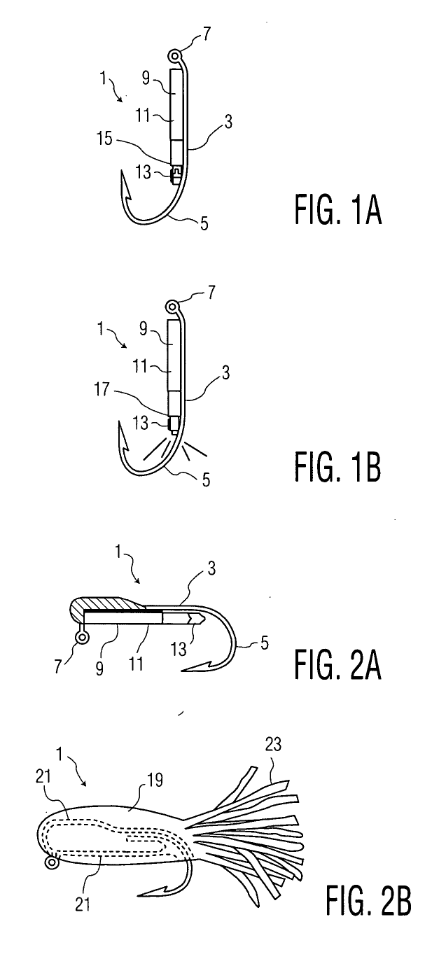

The preferred embodiments of the present invention will now be described with reference to FIGS. 1A to 9 of the drawings. Identical elements in the various figures are designated with the same reference numerals.

As seen in FIG. 1A, the illuminated fish hook of the present invention does not significantly change the profile of the existing hook to which it is added. In this embodiment, that basic hook is a simple standard hook. The illuminated fish hook of the present invention is shown generally at 1. It comprises a shaft, 3, at one end of which is a line connector; in this instance the ring, 7; and at the other end of which is the barbed hook, 5. As shown, a self-contained battery light unit, 9, is permanently attached to the shaft of hook. The unit, 9, comprises a battery, 11, and a light source; in this instance, LED, 13. In this preferred embodiment the unit has a push-pull, on-off switch, 15. In an alternative construction, the on/off switch may be located along the length of the battery, and may be a push-on, push-off switch. As shown at 15 in FIG. 1A, the switch is open and the light is off. In FIG. 1B, the light source, 13, has been pushed in, towards the battery, closing the switch, as shown at 17, and turning on the light. In this preferred embodiment, the LED is powered by a lithium three volt battery.

In constructing the illuminated hook of the present invention, the self-contained battery light unit used is made in Korea by Mirae Battery and sold in the United States by Lindy, under the name Nite Brite™, as a Replacement battery for a lighted float bobber. This “replacement unit” comes in three sizes: R-316(3×16 mm), R-327(3×27 mm), and R-435(4×35 mm), and is easily attached to the shaft of the hook by any known means such as soldering or gluing. The lights come in a number of colors, such as green, orange and red. The different color lights provide fishermen with an array of color combinations simply by changing the color of the soft rubber baits. This particular battery light unit is inexpensive and has a battery life of 20 hours. Thus the fisherman is not pressed to turn the light off to preserve the battery life. In alternative embodiments, the light source and battery need not be a self-contained unit. It is only required that both the light source and the battery be attached to the hook. While the light source in the preferred embodiment may be switched off, it is only necessary that the light unit have means for turning the light source on.

FIG. 2A illustrates an illuminated tube head jig head hook. As in the FIGS. 1A and 1B, the battery light unit is attached to the shaft of the hook along the inside of the hook, with a light source disposed towards the hook end of the shaft. It is understood to that the unit may be attached at any portion of the surface of the shaft, and that the light source may be disposed toward the line connector end a shaft, and still achieve many of the benefits of the present invention.

FIG. 2B illustrates the illuminated hook of FIG. 2A, disposed through the preformed channel, 21, of an artificial tube tail bait, 19, such as those conventionally made of “wiggly” rubber. This particular artificial bait fish includes than a number of movable parts, 23, resembling the tail of the natural fish it is meant to mimic.

Because of the slicing action of the barbed hook, and the shape and disposition of the battery light unit along the shaft, this hook may be easily inserted into an artificial bait fish without a preformed channel. Similarly, this hook may be easily used with live bait, as the addition of the light battery unit does not substantially alter the profile of the hook. However, the addition of the bright, long-lasting light source provides a tremendous improvement for attracting fish, especially while using the keeper style hook embodiment.

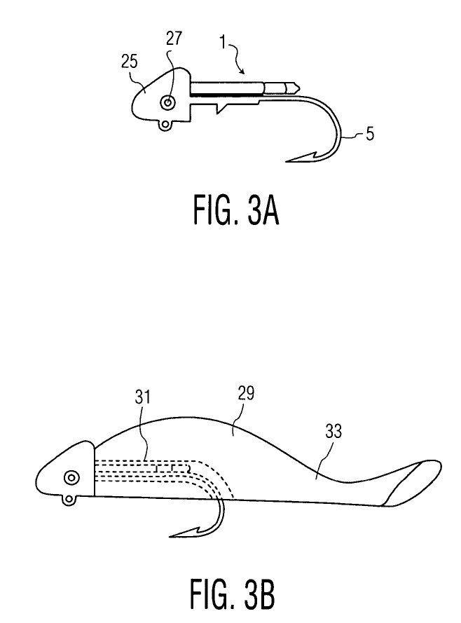

FIG. 3A illustrates an illuminated fish hook according to the present invention, formed with a shad head jig head hook. As shown, shad head jig head hook has a head portion, 25, with an eye, 27, to increase its attractiveness to fish. In this preferred embodiment the self-contained battery light unit is easily accommodated along the outer surface of the shaft of the hook. Because the unit so closely parallels the shaft, this illuminated hook may be used with substantially any piece of soft tackle that may be used with a simple shad head jig head hook. For instance, in FIG. 3B, the hook is shown disposed through the preformed channel, 31, of an artificial bait fish, 29, with flexible tail, 33.

In fact, the illuminated fish hook of the present invention may be formed with many configurations of fish hooks, such as Aberdeen hooks, bait holder hooks, weighted hooks, weedless hooks, offset hooks, trailer hooks, treble hooks, Keeper Hooks, snelled hooks, and fly hooks for fly fishing. In addition, illuminated fish hooks of the present invention may be easily constructed in many jig type configurations, such as round jig heads, football jig heads, bullet jig heads, cross eyed jig heads, tube head jig heads, stand up jig heads, floating jig heads and shad jig heads. The hooks can be used with just about any soft bait, such as worms, trailers, grubs, craws, lizards, jerk baits and tubes. Universally, with any hook design, and with any bait, the illuminated fish hook of the present invention will attract and catch more fish, especially in turbid or low light water conditions.

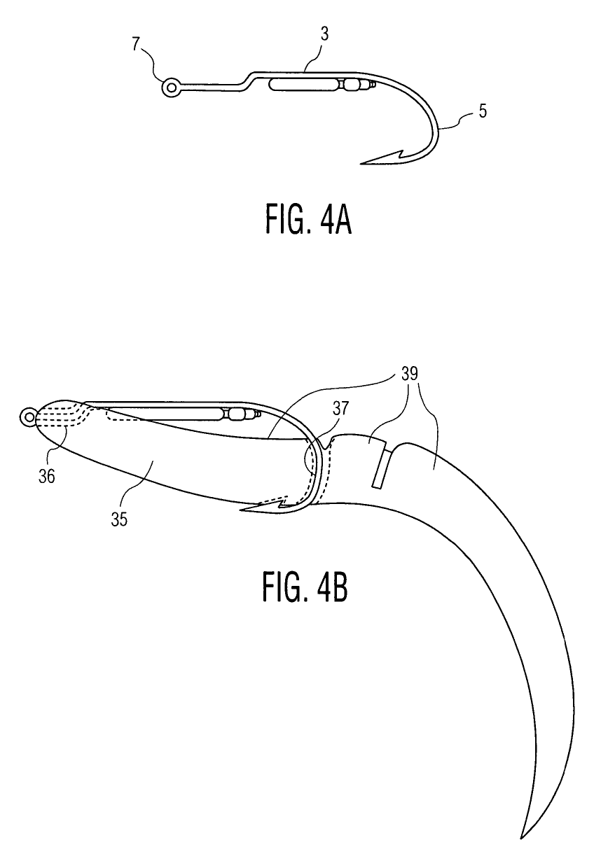

FIG. 4A illustrates an illuminated offset worm hook according to the present invention. In this preferred construction the self-contained battery light unit is attached to the inside surface of the shaft, as shown. As seen in FIG. 4B this hook may be used in conjunction with a SLUG-GO artificial stickbait eel or rubber worm, 35. The SLUG-GO has two preformed channels, 36 and 37, for the line connector end of the shaft, and the hook, thereby stringing a portion of the body of bait along the length of the shaft. The long body is formed a flexible material, so that its movement in the water will mimic that of the corresponding live bait. In addition to body has been formed in segments, 39, to add twists, or jerks, mimicking the propelling motion of the corresponding live bait.

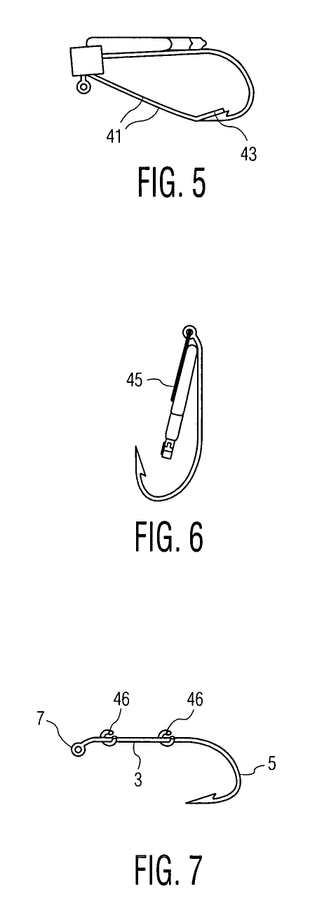

FIG. 5 illustrates the illuminated weedless hook of the present invention. A wire strand, 41, extends from the line connector end of the shaft across to the barbed hook, forms a loop, 43, around the hook, and extends back to, and is attached near the line connector end shaft. The wire is tensioned against the hook, but the loop is easily pushed in, and easily released from the hook, opening up the hook for the fish. Thus the tensioned wires prevent snagging the hook on weeds, but allow it to hook the fish. As may be seen in FIG. 5, the self-contained battery light unit may be easily disposed along the outside surface of the shaft, without disturbing the action and function of the wires of the weedless hook.

FIG. 6 illustrates an illuminated keeper type hook according to the present invention. As shown, the self-contained battery like unit is attached along the keeper rod, 45. In an alternative construction, the unit may be secured along the shaft of the hook, however, in the construction shown the light can be inserted into the head of virtually any softbait available, such as, worms, craws, grubs, lizards, etc., increasing the attractiveness of the bait to the fish. In fact, in the construction shown, it may not be necessary to add any other bait or attraction to the keeper rod of the hook.

FIG. 7 illustrates a trailer hook with the means, 46, for attaching a self-contained battery light unit to the shaft. In the particular embodiment shown the means comprise flexible fastening clips which may be constructed of either metal or plastic, each snap on fastening dip comprising two opposed, arcuate, flexible legs. The self-contained battery light unit can be pushed through the two legs, which separate to receive the unit, but snap back to retain it. Two snap on fastenings are shown, to accommodate the front of the back ends of the battery unit, to firmly secure to the shaft of the hook. With this particular embodiment if the self-contained battery light unit used with the hook needs to be replaced the used battery light unit can be snapped and a new battery light unit can be snapped in.

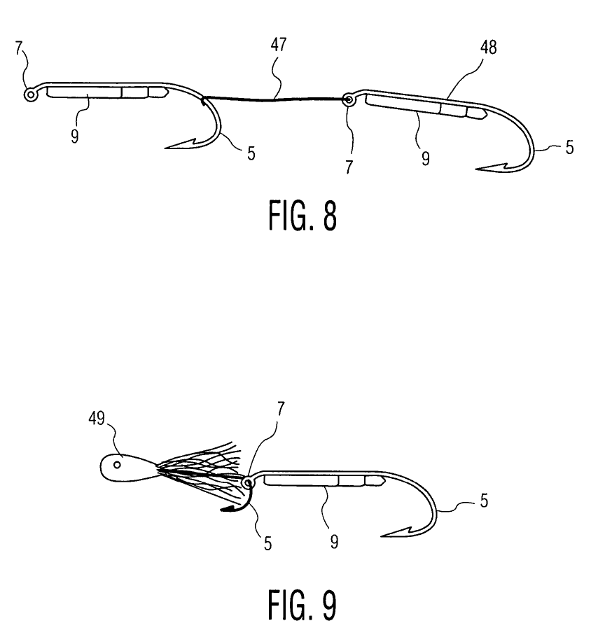

FIG. 8 illustrates a double hook arrangement in which a wire, 47, is used to connect the hooks, each with a self-contained battery light unit. Such an arrangement may be required for the larger and longer rubber bait. The trailing hook can be threaded through the rubber bait, emergin at the other end so it is available to catch the fish.

FIG. 9 illustrates a trailer hook arrangement of fish hooks, comprising a shad lure, 49, having a hook, 5, which has been passed through the line connector, 7, of another hook having a self-contained battery light unit according to the present invention, in the embodiment shown, a trailer hook.

There has thus been shown and described a novel lighted fish hook which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. An illuminated fish hook comprising:
(a) a hook comprising a shaft, with a curved hook at one end, and a line connector that the other end, and
(b) a light and a battery, attached to the shaft of the hook.

2. The illuminated fish hook of claim 1, further comprising a switch, to turn the light on and off.

3. The fish hook of claim 1, wherein the light and battery comprise a self-contained battery light unit.

4. The illuminated fish hook of claim 3, wherein the self-contained battery light unit further comprises a switch, to turn the light on and off.

5. The illuminated fish hook of claim 1, wherein the light is an LED.

6. The illuminated fish hook of claim 5, wherein the LED with battery is soldered to the shaft.

7. The illuminated fish hook of claim 5, wherein the LED with battery is glued or epoxyed to the shaft.

8. The illuminated fish hook of claim 1, further comprising a head attached to the shaft at the line connector end.

9. The illuminated fish hook of claim 1, wherein the hook is a shad jig head hook.

10. The illuminated fish hook of claim 1, wherein the hook is a keeper hook.

11. The illuminated fish hook of claim 1, wherein the hook is a tube head jig head.

12. The illuminated fish hook of claim 1, wherein the hook is a weedless hook.

13. An illuminated fish hook comprising:
(a) a hook comprising a shaft, with a curved hook at one end, and a line connector that the other end, and
(b) a keeper rod attached to the shaft near the line connector; and
(c) a light and a battery, attached to the keeper rod.

14. The illuminated fish hook of claim 13, further comprising a switch, to turn the light on and off.

15. The illuminated fish hook of claim 13, wherein the light is an LED.

16. The illuminated fish hook of claim 13, further comprising a switch, to turn the LED on and off.

17. The fish hook of claim 13, wherein the LED with battery is soldered to the keeper rod.

18. The fish hook of claim 13, wherein the LED with battery is glued or epoxyed to the keeper rod.

19. An illuminated, double fish hook arrangement comprising:
two hooks, each comprising a shaft, with a curved hook at one end, and a line connector that the other end, and a light and a battery, attached to the shaft of each hook, and a wire extending from the hook of one of said illuminated fish hooks to the line connector of the other of said illuminated fish hooks.

20. A piggybacked illuminated fish hook, comprising the illuminated fish hook of claim 1, wherein a fishing lure with hook if connected to the illuminated hook, the hook of the lure extending through the line connector of the illuminated hook.
